(19) United States
(12) Patent Application Publication
(10) Pub. No.: US 2026/0103611 A1
(43) Pub. Date: Apr. 16, 2026

(54) TRANSFER INK AND TRANSFER METHOD THEREOF

(71) Applicant: ASUSTEK COMPUTER INC., TAIPEI (TW)

(72) Inventors: Guo-Lin YANG, TAIPEI (TW); Po-Wen HUANG, TAIPEI (TW); Yu-Chun YANG, TAIPEI (TW); Er-Bao NIU, TAIPEI (TW); Tao CHEN, TAIPEI (TW)

(21) Appl. No.: 19/019,783

(22) Filed: Jan. 14, 2025

(30) Foreign Application Priority Data
Oct. 11, 2024 (CN) 202411418521.9

(51) Int. Cl. C09D 11/101; B41M 5/00; B41M 5/382; C09D 11/033; C09D 11/102

(52) U.S. Cl. CPC C09D 11/101; B41M 5/0011; B41M 5/38214; C09D 11/033; C09D 11/102

(57) ABSTRACT

The present disclosure provides a transfer ink. The transfer ink includes 55 wt %-70 wt % of a polymeric prepolymer, 11 wt %-16 wt % of a photosensitive monomer, 0.8 wt %-1.7 wt % of a photoinitiator, 6 wt %-11 wt % of liquid, 12 wt %-22 wt % of wear-resistant acrylic mixed reaction resin, and a solvent. The present disclosure also provides a transfer method by using the transfer ink.

### CROSS-REFERENCE TO RELATED APPLICATION

This application claims the priority benefit of Chinese application serial No. 202411418521.9, filed on Oct. 11, 2024. The entirety of the above-mentioned patent application is hereby incorporated by reference herein and made a part of the specification.

### BACKGROUND OF THE INVENTION

### Field of the Invention

The present disclosure relates to the technical field of transfer, particularly relates to a transfer ink and a transfer method thereof.

### Description of the Related Art

In order to form a decorative pattern on the surface of a product, a commonly used surface treatment technique is using a transfer film. Further, depending on the position where the film is placed, in-mold roller (IMR) and out-mold roller (OMR) decorations can be distinguished.

However, the transfer film formed by using a traditional transfer ink has poor physical properties. Specifically, a surface film layer formed by the traditional transfer ink has the wear resistance times born by a friction test carried out by matching a wool felt with a 200 g load of less than 2,000 times, the wear resistance times born by a friction test carried out by matching rolling-tape friction paper (RCA) of less than 200 times, the wear resistance times born by a wear resistance test carried out by matching an eraser of less than 300 times, the wear resistance times born by a wear resistance test carried out by matching alcohol of less than 300 times, and the water drop contact angle of less than 80°. Therefore, the surface film layer has poor wear resistance, and the surface of the film layer is easy to be polluted, difficult to be cleaned and intolerant to fingerprints.

### BRIEF SUMMARY OF THE INVENTION

The present disclosure provides a transfer ink. The transfer ink includes 55 wt %-70 wt % of a polymeric prepolymer, 11 wt %-16 wt % of a photosensitive monomer, 0.8 wt %-1.7 wt % of a photoinitiator, 6 wt %-11 wt % of liquid, 12 wt %-22 wt % of wear-resistant acrylic mixed reaction resin, and a solvent.

By using the transfer ink, the present disclosure provides a transfer method, including the following steps: first, providing a plastic film; then forming a transfer ink layer on the plastic film by using a transfer ink to form a transfer film, wherein the transfer ink includes 55 wt %-70 wt % of a polymeric prepolymer, 11 wt %-16 wt % of a photosensitive monomer, 0.8 wt %-1.7 wt % of a photoinitiator, 6 wt %-11 wt % of liquid, 12 wt %-22 wt % of wear-resistant acrylic mixed reaction resin, and a solvent; next, placing the transfer film in a mould; then filling a structural material into the mould to form a structural member and transferring the transfer ink layer from the transfer film to a surface of the structural member; and then applying a curing treatment to the transfer ink layer to form a surface film layer.

By using the transfer ink, the present disclosure provides another transfer method, including the following steps: first, providing a plastic film; then forming a transfer ink layer on the plastic film by using a transfer ink to form a transfer film, wherein the transfer ink includes 55 wt %-70 wt % of a polymeric prepolymer, 11 wt %-16 wt % of a photosensitive monomer, 0.8 wt %-1.7 wt % of a photoinitiator, 6 wt %-11 wt % of liquid, 12 wt %-22 wt % of wear-resistant acrylic mixed reaction resin, and a solvent; next, providing a structural member, wherein the structural member is made of a structural material and has a surface; then tightly covering the surface with the transfer film; and then applying a curing treatment to the transfer ink layer to transfer the transfer ink layer to the surface and forming a surface film layer on the surface.

Compared with a traditional transfer film, the transfer ink provided by the present invention can form a surface film layer with better physical properties on a surface of an injection-molded object. Specifically, a surface film layer formed by the transfer ink provided by the present invention has the wear resistance times born by a friction test carried out by matching a wool felt with a 500 g load of greater than 100,000 times, the wear resistance times born by a friction test carried out by matching rolling-tape friction paper (RCA) of greater than 1,000 times, the wear resistance times born by a wear resistance test carried out by matching an eraser of greater than 13,000 times, the wear resistance times born by a wear resistance test carried out by matching alcohol of less than 13,000 times, and the water drop contact angle of greater than 115°. Therefore, the transfer ink provided by the present invention can form a high-wear-resistant, easy-to-clean, anti-fingerprint and anti-pollution surface film layer on a surface of an injection-molded structural member.

### BRIEF DESCRIPTION OF THE DRAWINGS

FIG. 1 is a flow diagram of the transfer method provided by one embodiment of the present disclosure;

FIGS. 2A to 2D are structure diagrams corresponding to the transfer method shown in FIG. 1;

FIG. 3 is a flow diagram of the transfer method provided by another embodiment of the present disclosure; and

FIGS. 4A to 4C are structure diagrams corresponding to the transfer method shown in FIG. 3.

### DETAILED DESCRIPTION OF THE EMBODIMENTS

The specific embodiments of the present disclosure are described in detail below with reference to the accompanying drawings. According to the following description and claims, the advantages and features of the present disclosure will be clearer. It should be noted that the drawings all adopt very simplified forms and all use imprecise ratios, which are only used for the purpose of conveniently and clearly assisting in describing the embodiments of the present disclosure.

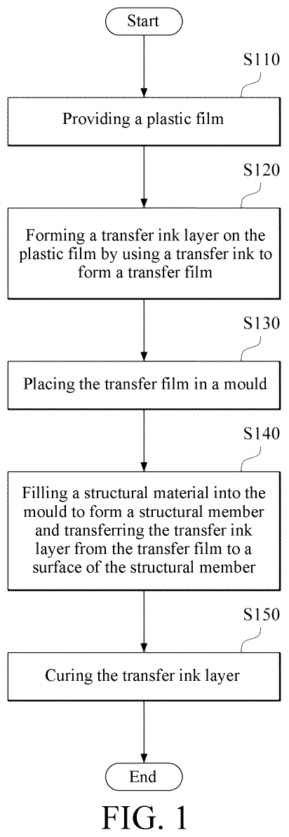

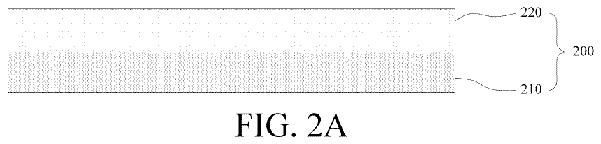

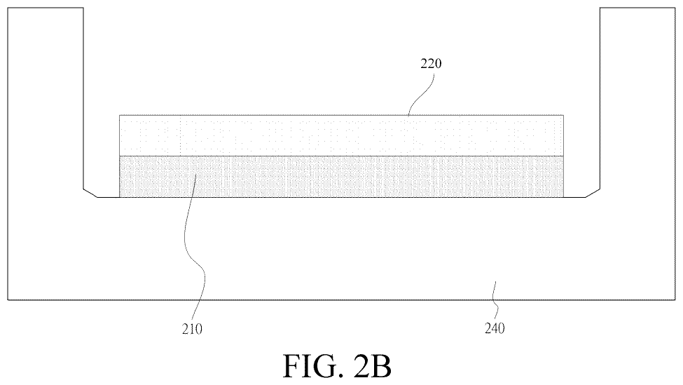

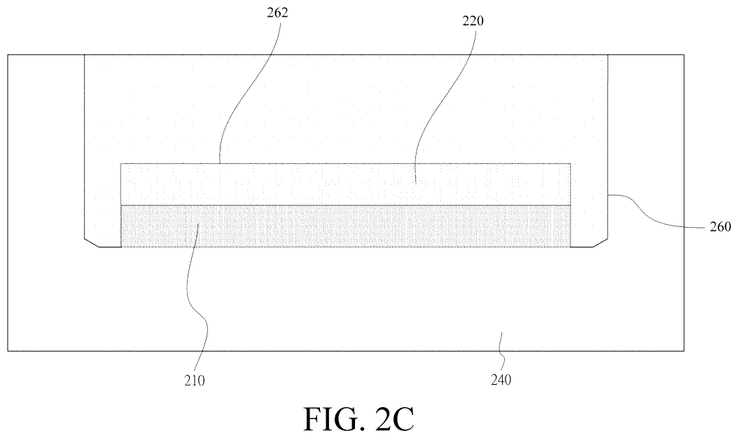

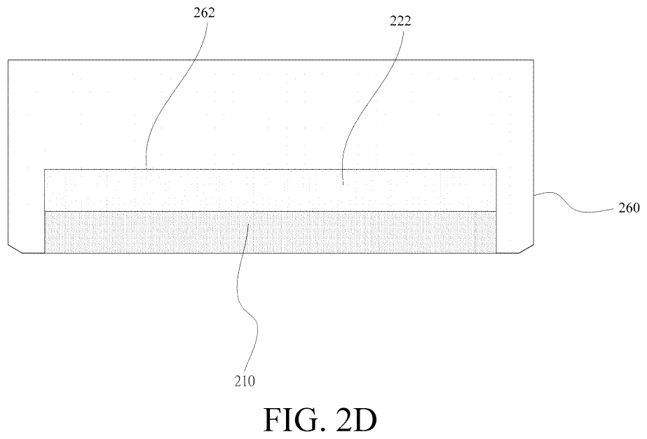

FIG. 1 shows a flow diagram of the transfer method provided by one embodiment of the present disclosure. FIGS. 2A to 2D are structure diagrams corresponding to the transfer method shown in FIG. 1.

As shown in FIG. 1, the transfer method provided by the present disclosure includes the following steps.

First, as shown in step S110 and also referring to FIG. 2A, a plastic film 210 is provided. In one embodiment, the plastic film 210 may be a PET film or a PC film.

Then, as shown in step S120 and also referring to FIG. 2A, a transfer ink layer 220 is formed on the plastic film 210 by using a transfer ink to form a transfer film 200. The transfer ink includes 55 wt %-70 wt % of a polymeric prepolymer, 11 wt %-16 wt % of a photosensitive monomer, 0.8 wt %-1.7 wt % of a photoinitiator, 6 wt %-11 wt % of liquid, 12 wt %-22 wt % of wear-resistant acrylic mixed reaction resin, and a solvent.

In one embodiment, the solvent includes pure water. In one embodiment, the wear-resistant acrylic mixed reaction resin may be a copolymer of butyl methacrylate (BMA) and methyl methacrylate (MMA). In one embodiment, the liquid includes pure water. Besides, in one embodiment, the wear-resistant acrylic mixed reaction resin may also be prepared by adding nanoscale aluminium oxide or nanoscale silicon dioxide into acrylic resin to improve the wear resistance of the resin.

Next, as shown in step S130 and also referring to FIG. 2B, the transfer film 200 is placed in a mould 240. Specifically, the step is placing and positioning the transfer film 200 in the mould 240 in the manner of the plastic film 210 facing outward (i.e., directly contacting the mould 240) and the transfer ink layer 220 facing inward.

Then, as shown in step S140 and also referring to FIG. 2C, a structural material is filled into the mould 240 to form a structural member 260 and the transfer ink layer 220 is transferred from the transfer film 200 to a surface 262 of the structural member 260. The surface 262 may be a flat surface or a curved surface.

In one embodiment, the structural material may be a plastic material. Step S140 of filling the structural material into the mould 240 to form the structural member 260 includes filling the structural material into the mould 240 by an injection molding mode to form the structural member 260. However, the present disclosure is not limited thereto. In other embodiments, the structural material may also be a metal material.

Then, as shown in step S150 and also referring to FIG. 2D, the transfer ink layer 220 is cured to form a surface film layer 222. Then the plastic film 210 is peeled off from the structural member 260, leaving the cured surface film layer 222 on the structural member 260. In one embodiment, the curing treatment is a photocuring treatment.

However, the present disclosure is not limited thereto. In other embodiments, the plastic film 210 may also remain on the surface 262 of the structural member 260 to protect a transfer ink pattern.

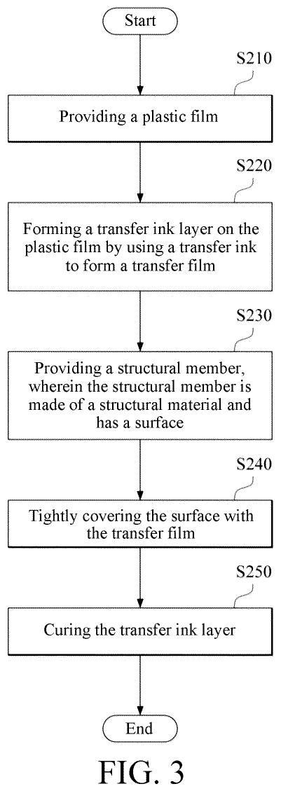

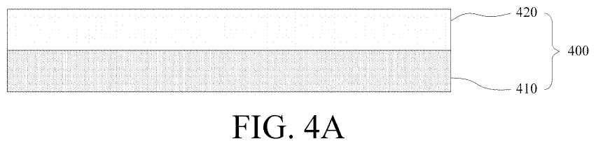

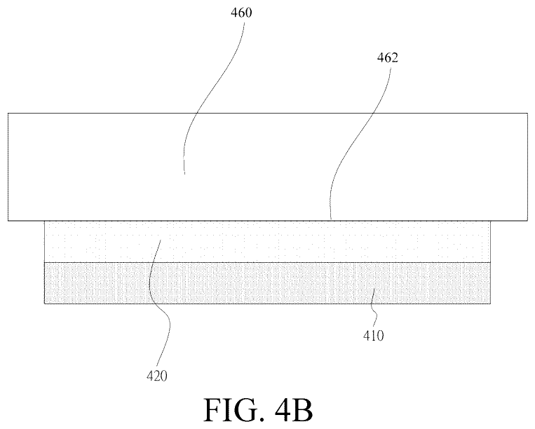

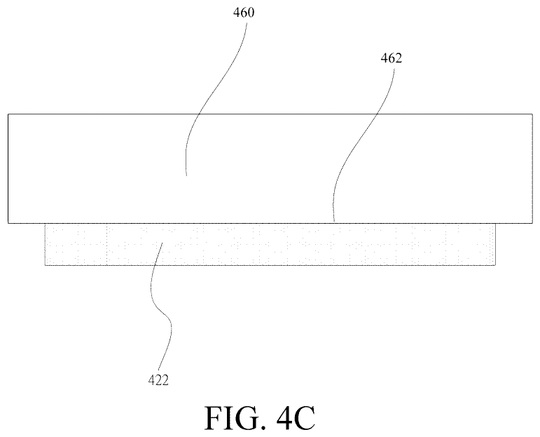

FIG. 3 shows a flow diagram of the transfer method provided by another embodiment of the present disclosure. FIGS. 4A to 4C are structure diagrams corresponding to the transfer method shown in FIG. 3.

As shown in FIG. 3, the transfer method provided by the present embodiment includes the following steps.

First, as shown in step S210 and also referring to FIG. 4A, a plastic film 410 is provided. In one embodiment, the plastic film 410 may be a PET film or a PC film.

Then, as shown in step S220 and also referring FIG. 4A, a transfer ink layer 420 is formed on the plastic film 410 by using a transfer ink to form a transfer film 400. The transfer ink includes 55 wt %-70 wt % of a polymeric prepolymer, 11 wt %-16 wt % of a photosensitive monomer, 0.8 wt %-1.7 wt % of a photoinitiator, 6 wt %-11 wt % of liquid, 12 wt %-22 wt % of wear-resistant acrylic mixed reaction resin, and a solvent.

Next, as shown in step S230 and also referring to FIG. 4B, a structural member 460 is provided, wherein the structural member 460 is made of a structural material and has a surface 462. In one embodiment, the structural material used to form the structural member 460 is a metal material, such as an aluminum alloy, an aluminum magnesium alloy, or a lithium magnesium alloy. However, the present disclosure is not limited thereto. In other embodiments, a plastic material or a ceramic material may be used as the structural material. Besides, in other embodiments, the structural member 460 may also be formed by heterogeneous bonding using a plurality of different materials.

Next, as shown in step S240 and also referring to FIG. 4B, the surface 462 of the structural member 460 is tightly covered with the transfer film 400.

In one embodiment, the step of covering the surface 462 of the structural member 460 with the transfer film 400 includes pumping out air between the surface 462 and the transfer film 400 to have the surface 462 tightly covered by the transfer film 400.

Then, as shown in step S250 and also referring to FIG. 4C, the transfer ink layer 420 is cured to transfer the transfer ink layer 420 to the surface 462 and form a surface film layer 422 on the surface 462. Then the plastic film 410 is peeled off from the structural member 460, leaving the cured surface film layer 422 on the structural member 460. In one embodiment, the curing treatment is a photocuring treatment, such as by illuminating the structural member 460 with an ultraviolet light illumination device.

However, the present disclosure is not limited thereto. In other embodiments, the plastic film 410 may also remain on the surface 462 of the structural member 460 to protect a transfer ink pattern.

Compared with a traditional transfer film, the transfer ink provided by the present invention can form transfer films 200 and 400 with better physical properties on surfaces 262 and 462 of injection-molded objects. Specifically, surface film layers 222 and 422 formed by the transfer ink provided by the present invention has the wear resistance times born by a friction test carried out by matching a wool felt with a 500 g load of greater than 100,000 times, the wear resistance times born by a friction test carried out by matching rolling-tape friction paper (RCA) of greater than 1,000 times, the wear resistance times born by a wear resistance test carried out by matching an eraser of greater than 13,000 times, the wear resistance times born by a wear resistance test carried out by matching alcohol of less than 13,000 times, and the water drop contact angle of greater than 115°. Therefore, the transfer ink provided by the present invention can form high-wear-resistant, easy-to-clean, anti-fingerprint and anti-pollution surface film layers 222 and 422 on surfaces 262 and 462 of injection-molded structural members 260 and 460.

Although the present invention is disclosed as the foregoing in the manner of embodiments, however, which are not used to limit the present invention, any person skilled in the art can make various changes and modification without departing from the concept and scope of the present invention. Therefore, the protection scope of the present invention is determined by the attached claims.

What is claimed is:

1. A transfer ink, including:
55 wt %-70 wt % of a polymeric prepolymer;
11 wt %-16 wt % of a photosensitive monomer;
0.8 wt %-1.7 wt % of a photoinitiator;
6 wt %-11 wt % of liquid;
12 wt %-22 wt % of wear-resistant acrylic mixed reaction resin; and
a solvent.

2. The transfer ink according to claim 1, wherein the solvent includes pure water.

3. The transfer ink according to claim 1, wherein the wear-resistant acrylic mixed reaction resin includes nanoscale aluminium oxide or nanoscale silicon dioxide.

4. A transfer method, including:
providing a plastic film;
forming a transfer ink layer on the plastic film by using a transfer ink to form a transfer film, wherein the transfer ink includes 55 wt %-70 wt % of a polymeric prepolymer, 11 wt %-16 wt % of a photosensitive monomer, 0.8 wt %-1.7 wt % of a photoinitiator, 6 wt %-11 wt % of liquid, 12 wt %-22 wt % of wear-resistant acrylic mixed reaction resin, and a solvent;
placing the transfer film in a mould;
filling a structural material into the mould to form a structural member and transferring the transfer ink layer from the transfer film to a surface of the structural member; and
applying a curing treatment to the transfer ink layer to form a surface film layer.

5. The transfer method according to claim 4, wherein the structural material is a plastic material.

6. The transfer method according to claim 4, wherein the curing treatment is a photocuring treatment.

7. The transfer method according to claim 4, wherein the plastic film is a PET film or a PC film.

8. The transfer method according to claim 4, wherein the step of filling the structural material into the mould to form the structural member and transferring the transfer ink layer from the transfer film to the surface of the structural member includes filling the structural material into the mould by injection molding to form the structural member.

9. A transfer method, including:
providing a plastic film;
forming a transfer ink layer on the plastic film by using a transfer ink to form a transfer film, wherein the transfer ink includes 55 wt %-70 wt % of a polymeric prepolymer, 11 wt %-16 wt % of a photosensitive monomer, 0.8 wt %-1.7 wt % of a photoinitiator, 6 wt %-11 wt % of liquid, 12 wt %-22 wt % of wear-resistant acrylic mixed reaction resin, and a solvent;
providing a structural member, wherein the structural member is made of a structural material and has a surface;
covering the surface with the transfer film; and
applying a curing treatment to the transfer ink layer to transfer the transfer ink layer to the surface and forming a surface film layer on the surface.

10. The transfer method according to claim 9, wherein the structural material is a plastic material.

11. The transfer method according to claim 9, wherein the curing treatment is a photocuring treatment.

12. The transfer method according to claim 9, wherein the plastic film is a PET film or a PC film.

13. The transfer method according to claim 9, wherein the step of covering the surface with the transfer film includes pumping out air between the surface and the transfer film to have the surface tightly covered by the transfer film.
